(19) United States
(12) Patent Application Publication
(10) Pub. No.: US 2020/0356548 A1
(43) Pub. Date: Nov. 12, 2020

(54) METHODS AND SYSTEMS FOR FACILITATING MESSAGE FORMAT DISCOVERY IN ONLINE TRANSACTION PROCESSING

(71) Applicant: MASTERCARD INTERNATIONAL INCORPORATED, Purchase, NY (US)

(72) Inventors: Mahesh GUJALE, Pune (IN); Surend Raj DHARMAPAL, Chennai (IN); Suresh ANANTHANARAYANAN, Pune (IN); Aravindan RAMAMOORTHY, Coimbatore (IN)

(73) Assignee: MASTERCARD INTERNATIONAL INCORPORATED, Purchase, NY (US)

(21) Appl. No.: 16/870,294

(22) Filed: May 8, 2020

(30) Foreign Application Priority Data
May 9, 2019 (SG) 10201904175U

(51) Int. Cl. G06F 16/23; G06Q 20/40; G06F 16/25; H04L 12/58

(52) U.S. Cl. CPC G06F 16/2379; H04L 51/18; G06F 16/258; G06Q 20/405

(57) ABSTRACT

Embodiments provide methods, and systems for facilitating message format discovery in online transaction processing. A method includes receiving, by a server system associated with a payment network, a message comprising a payment service request via a communication channel from an application in a message format of a plurality of message formats. The server system includes a rule engine and a rule data dictionary. The method includes applying, by the server system, one or more rules fetched by the rule engine from the rule data dictionary until the message format is identified. At least one rule of the one or more rules is applied based on matching one or more characters of the message with a pattern corresponding to the at least one rule. Upon successful identification of the message format, the method includes facilitating, by the server system, processing of the payment service request.

### CROSS-REFERENCE TO RELATED APPLICATIONS

This application claims priority to Singaporean Application Serial No. 10201904175U, filed May 9, 2019, which is incorporated herein by reference in its entirety. This application is related to PCT application no. PCT/US2020/028049, filed on Apr. 14, 2020, which also claims priority to Singaporean Application Serial No. 10201904175U.

### TECHNICAL FIELD

The present disclosure relates to online transaction processing (OLTP) and, more particularly to, methods and systems for facilitating message format discovery in online financial transactions.

### BACKGROUND

Payment interchange networks facilitate the exchange of financial transaction data between financial institutions that are members of the payment interchange networks for processing payment card-based transactions. The use of credit cards and debit cards (examples of a payment card) to make purchases often involves the electronic transfer of funds, including electronic messages of a request and then an authorization to debit a given amount from one account and credit that amount to another account. For example, purchasing a product over the Internet may involve the electronic submission of a credit card number, an electronic communication to the credit card issuer for authorization of a total purchase price, and an electronic debiting of the customer's account when the purchase process is completed. Such financial transaction data are exchanged by means of messages among the entities (e.g., customers such as the issuer banks and the acquirer banks) in various types of standard and non-standard message formats.

Some examples of the standard message formats conventionally used are International Organization for Standardization (ISO) 8583, ISO 20022 and the like. For example, a payment interchange network such as Mastercard® payment system interchange network allows authorization communications between the entities using ISO 8583 message format. Currently, each customer of the payment interchange network (hereinafter referred to as payment network) uses a separate dedicated source port tied with a particular and preferred message format for sending the message to the payment network. The source ports are tied with particular message formats such that other message formats on the same ports cannot be transmitted or received. The payment network also needs to configure the destination port tied with the same message format at the payment network's end to receive the message from the customer. Examples of the various message formats used by the customers include Extensible Markup Language (XML), JavaScript Object Notation (JSON), Comma-separated values (CSV) etc. which may be different than the standard format used by the payment network. This requires a lot of network and hardware configuration on both the customer's side and the payment network's side.

Therefore, discovery of the message format of the received message at the payment network is of prime importance in order to identify the underlying message and proceed the payment transaction after identifying the message. Conventionally, the message format discovery is carried out using dedicated ports method at each end. Message format discovery is also required in a scenario when a non-customer bank needs to send the messages to the payment network. In such case, the non-customer bank has to send the message in the format acceptable by the payment network. Transformation into the message format acceptable by the payment network is again a cumbersome process for the non-customer bank.

Accordingly, techniques are desired for performing message format discovery without having a need of separate ports configuration per format at the ends of senders and receivers.

### SUMMARY

Various embodiments of the present disclosure provide systems, methods, electronic devices and computer program products for facilitating message format discovery in online transaction processing.

In an embodiment, a computer-implemented method for processing a payment service request is disclosed. The method includes receiving, by a server system associated with a payment network, a message including the payment service request via a communication channel from an application in a message format of a plurality of message formats. The server system includes a rule engine and a rule data dictionary. The method includes applying, by the server system, one or more rules fetched by the rule engine from the rule data dictionary until the message format is identified. At least one rule of the one or more rules is applied based on matching one or more characters of the message with a pattern corresponding to the at least one rule. Upon successful identification of the message format, the method includes facilitating, by the server system, processing of the payment service request.

In another embodiment, a server system for processing a payment service request is provided. The server system includes a communication interface configured to receive a message including the payment service request via a communication channel from an application in a message format of a plurality of message formats. The server system includes a rule data dictionary comprising of one or more rules. The server system includes a rule data engine configured to fetch one or more rules from the rule data dictionary until the message format is identified. The server system further includes a memory comprising executable instructions and a processor communicably coupled to the communication interface, the rule data dictionary and the rule engine. The processor is configured to execute the instructions to cause the server system at least to apply the one or more rules fetched by the rule engine from the rule data dictionary until the message format is identified. At least one rule of the one or more rules is applied based on matching one or more characters of the message with a pattern corresponding to the at least one rule. The processor is further configured to execute the instructions to cause the server system to facilitate processing of the payment service request upon successful identification of the message format.

In yet another embodiment, a rule data dictionary in a server system associated with a payment network is disclosed. The rule data dictionary includes a listing of one or more rules. The one or more rules includes a parent-child relationship. The rule data dictionary further includes a listing of patterns. Each pattern corresponds to each rule of the one or more rules. The rule data dictionary further includes a listing of parent formats. A parent format is identified based on matching one or more characters of a message with at least one pattern of the listing of patterns. The rule data dictionary further includes a listing of child formats. At least one child format is identified based at least on identification of the parent format and on matching the one or more characters of the message with at least one pattern of the listing of patterns. The one or more rules are fetched by a rule engine associated with the server system from the rule data dictionary until a message format of the message received by the server system from an application is identified to process a payment service request.

### BRIEF DESCRIPTION OF THE FIGURES

For a more complete understanding of example embodiments of the present technology, reference is now made to the following descriptions taken in connection with the accompanying drawings in which:

FIG. 1 illustrates an example representation of an environment, related to at least some example embodiments of the present disclosure;

FIG. 2 represents a flow diagram representing facilitation of message format discovery in online transaction processing, in accordance with an example embodiment;

FIG. 3 represents a simplified schematic representation of a rule data dictionary for message format discovery, in accordance with an example embodiment;

FIGS. 4A & 4B respectively represent an example representation of a message format and an execution of steps of the flow diagram 200 for discovering the message format of FIG. 4A, in accordance with an example embodiment;

FIGS. 5A & 5B respectively represent another example representation of a message format and an execution of steps of the flow diagram 200 for discovering the message format of FIG. 5A, in accordance with an example embodiment;

FIG. 6 represents a flow diagram representing discovery of a message format during a payment transaction in a payment network, in accordance with an example embodiment;

FIG. 7 illustrates a flow diagram of a method for facilitating discovery of a message format in online transaction processing, in accordance with an example embodiment;

FIG. 8 is a simplified block diagram of a server system, in accordance with one embodiment of the present disclosure;

FIG. 9 is a simplified block diagram of an application server, in accordance with one embodiment of the present disclosure; and

FIG. 10 is a simplified block diagram of a payment server used for message format discovery, in accordance with one embodiment of the present disclosure.

The drawings referred to in this description are not to be understood as being drawn to scale except if specifically noted, and such drawings are only exemplary in nature.

### DETAILED DESCRIPTION

In the following description, for purposes of explanation, numerous specific details are set forth in order to provide a thorough understanding of the present disclosure. It will be apparent, however, to one skilled in the art that the present disclosure can be practiced without these specific details.

Reference in this specification to “one embodiment” or “an embodiment” means that a particular feature, structure, or characteristic described in connection with the embodiment is included in at least one embodiment of the present disclosure. The appearance of the phrase “in an embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

Moreover, although the following description contains many specifics for the purposes of illustration, anyone skilled in the art will appreciate that many variations and/or alterations to said details are within the scope of the present disclosure. Similarly, although many of the features of the present disclosure are described in terms of each other, or in conjunction with each other, one skilled in the art will appreciate that many of these features can be provided independently of other features. Accordingly, this description of the present disclosure is set forth without any loss of generality to, and without imposing limitations upon, the present disclosure.

### OVERVIEW

Various example embodiments of the present disclosure provide methods, systems, user devices and computer program products for facilitating message format discovery in online financial transactions.

In various example embodiments, the present disclosure facilitates a server system that includes a rule engine and a rule data dictionary collectively configured to provide message format discovery of the message received from an application.

In one embodiment, the server system is associated with a payment network (hereinafter referred to as payment server). The payment server receives a message from an application (e.g., a payment application) facilitated by a corresponding application server on a client device. The message is related to a payment service request. Some non-exhaustive examples of the payment service request include an authorization request, a payment transaction request, an acquirer reversal request, a batch upload request, an issuer response to financial request, a funds approval request, a funds approval response, an acquirer financial request, a savings account inquiry, a checking account inquiry and the like. The message is sent in a preferred message format by the application to the payment server. Some examples of the message formats include XML, JSON, ISO 8583, ISO 15002, Society for Worldwide Interbank Financial Telecommunication (SWIFT) and the like.

In one embodiment, the rule data dictionary includes a listing of one or more rules in a parent-child relationship, a listing of patterns, a listing of parent formats and a listing of child formats. Each pattern corresponds to each rule of the one or more rules. A parent format is identified based on matching one or more characters of the received message with at least one pattern. The parent format can have one or more children formats. At least one child format is identified based on identification of the parent format and based on matching the one or more characters of the message with at least one pattern. The rule data dictionary also includes a listing of values where each value forms a respective condition, and if the condition is true, the corresponding message format is considered as identified.

In one embodiment, the one or more rules are fetched by the rule engine from the rule data dictionary until the message format is identified. The fetched rules are applied by the payment server one by one until the message format is identified. Once the message format is identified, it is transformed into a standardized message format acceptable by the payment network. For example, the standardized message format is an ISO 8583 message format. After transformation, the message in the standardized message format is parsed to retrieve the payment service request. The payment service request is processed and transformed to a designated clearing message format for sending back to the application.

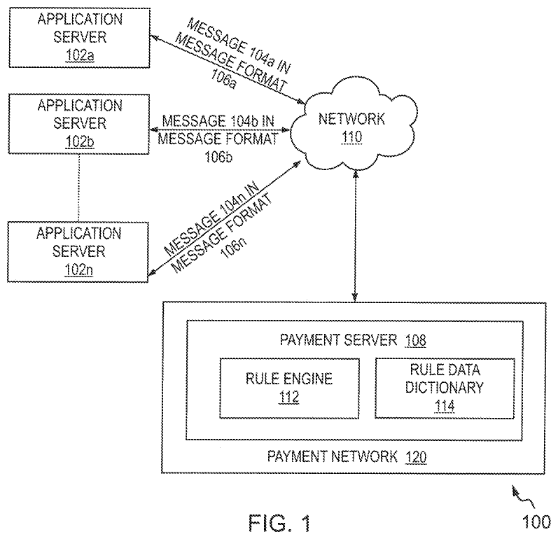

FIG. 1 illustrates an exemplary representation of an environment 100 related to at least some example embodiments of the present disclosure. In the illustrated environment 100, a plurality of application servers such as an application server 102a, an application server 102b to an application server 102n (hereinafter referred to as application servers 102a-n) are shown. The application servers 102a-n are capable of facilitating corresponding applications (not shown) that can be installed on various client devices (not shown) through various digital platforms. Examples of the client devices include, but are not limited to, a smartphone, a tablet, a personal digital assistant (PDA), a notebook, a POS terminal, a kiosk, an ATM or any electronic device having the capability to communicate with the application servers 102a-n via a communication network 110. For example, the client device may be a computer including a web browser on which an application server 102c hosts a web application, such that the application server 102c accessible to the client device using the Internet. Alternatively, the client device may be a POS terminal in a payment network such as the payment network 120 configured to accept user PIN for transmission to an application server 102e (e.g., an acquirer server) over the communication network 110.

The application servers 102a-n can take example of any server which is the administrative part of the application (not shown) and which stores data sent from the client device. In an example, the application server 102a (or the application server 102b) may be associated with a financial institution such as an “issuer bank” or “issuing bank” or simply “issuer” or simply “bank”, in which a user operating the client device may have an issuer account. The application server 102a is responsible for managing information of the user. The application server 102a includes an issuer database (not shown) for maintaining information such as one or more issuer accounts of the user, transaction history related information, permanent account number (PAN) with which the one or more issuer accounts are linked, etc.

Additionally, or alternatively, the application server 102b (or the application server 102c) may be associated with a merchant or a Point of Sale (POS) system network. For example, the application server 102b may be associated with an “acquirer bank” or “acquiring bank” or simply “acquirer”, in which a user operating the client device may have an acquirer account. Additionally, the application server 102n may be a digital wallet server.

In an example, the application server 102a being an acquirer server may receive information such as a payment card number of the payment card, expiry date, Card Verification Value (CVV) number, Personal Identification Number (PIN) and the like filled by the user while performing an online payment transaction using a payment card. Such information needs to be verified for authentication of the cardholder and his account balance to proceed the transaction. Using the payment network 120, the computers of the acquirer/the acquirer server or the merchant processor communicate with the computers of the issuer/the issuer server (another example of the application server) to determine whether the first user's account is in good standing and whether the purchase is covered by the first user's available account balance. Based on these determinations, authorization of the payment transaction is declined or accepted. When the authorization is accepted, the available balance of the first user's account is decreased.

In anon-limiting example, operations such as authentication of the cardholder and his account balance, PIN verification, CVV verification, PIN translation, credit card scoring, clearing payments, settlements of the payments among the entities of the payment network 120 etc. are performed by means of sending messages in particular message formats by the application servers 102a-n to a payment server 108 associated with the payment network 120. The payment network 120 may be used by payment cards issuing authorities as a payment interchange network as explained hereinabove. Examples of payment interchange network include, but are not limited to, Mastercard® payment system interchange network. The Mastercard® payment system interchange network is a proprietary communications standard promulgated by Mastercard® International Incorporated for the exchange of financial transaction data between financial institutions that are members of Mastercard® International Incorporated. (Mastercard is a registered trademark of Mastercard International Incorporated located in Purchase, N.Y.). Mastercard® payment system interchange network processes authorization communications using ISO 8583 (an example of the standard message format).

Each application server of the application servers 102a-n may use its own custom message format to send messages to the payment server 108. For example, the application server 102a sends a message 104a (e.g., PIN verification, an example of the payment service request) in a message format 106a (e.g., XML). The application server 102b sends a message 104b (e.g., CVV verification, another example of the payment service request) in a message format 106b (e.g., JSON). A plurality of message formats 106a, 106b . . . 106n (hereinafter alternatively referred to as message formats 106a-n) may be used by the application servers 102a-n to send the plurality of messages 104a, 104b . . . 104n (hereinafter alternatively referred to as messages 104a-n) to the payment server 108. Some non-exhaustive examples of the message formats 106a-n include ISO 8583-1987, ISO 8583-1993, ISO 8583-2003, ISO 20022, XML, JSON, CSV, Type-Length-Value or Tag-Length-Value (TLV) and the like.

In existing (conventional) payment service request methods (i.e., not in accordance with the present disclosure), the application servers 102a-n are configured to include separate ports per message formats to send the messages to the payment server 108 that further requires the payment server 108 to include the ports capable of receiving the messages in the same message formats. This requires a lot of network configuration at each end. In contrast to existing payment service request methods, by using the embodiments of the present disclosure the application servers 102a-n are facilitated to send the messages in any message format without having to worry about transformation of the message format acceptable by the payment server 108. To achieve this, the payment server 108 is shown to include a rule engine 112 and a rule data dictionary 114 capable of facilitating message format discovery of the received message. The payment server 108 is further configured to facilitate transformation of the message format into the one acceptable by the payment server 108.

The application servers 102a-n and the payment server 108 communicate with one another via the communication network 110. The communication network 110 may be a centralized network or may comprise a plurality of sub-networks that may offer a direct communication or may offer indirect communication. Examples of the communication network 110 may include any type of wired network, wireless network, or a combination of wired and wireless networks. A wireless network may be a wireless local area network (“WLAN”), a wireless wide area network (“WWAN”), or any other type of wireless network now known or later developed. Additionally, the communication network 110 may be or include the Internet, intranets, extranets, microwave networks, satellite communications, cellular systems, personal communication services (“PCS”), infrared communications, global area networks, or other suitable networks, etc., or any combination of two or more such networks.

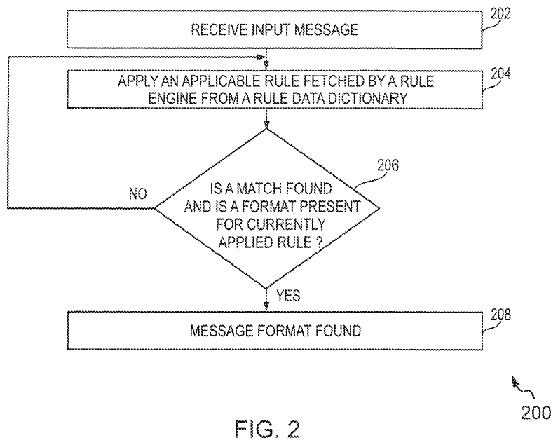

Since the message format discovery is performed by the payment server 108, an application server which is not a customer of the payment network 120 can also be enabled to send message/payment service request to the payment server 108 without having to transform the message format into the message format (ISO 8583) acceptable by the payment server 108. Some non-exhaustive example embodiments of message format discovery facilitated by the payment server 108 are described with reference to the following description, particularly with reference to FIGS. 2 to 10.

FIG. 2 represents a flow diagram 200 representing facilitation of message format discovery in online transaction processing, in accordance with an example embodiment. The sequence of operations of the flow diagram 200 may not be necessarily executed in the same order as they are presented. Further, one or more operations may be grouped together and performed in form of a single step, or one operation may have several sub-steps that may be performed in parallel or in sequential manner.

At 202, the payment server 108 receives an input message. The input message is received from any of the application servers 102a-n in any of the respective message formats 106a-n. The input message is related to one of the payment service requests. For example, the payment service request is about issuer response to a financial request received from an application server 102d in a message format ‘JSON’.

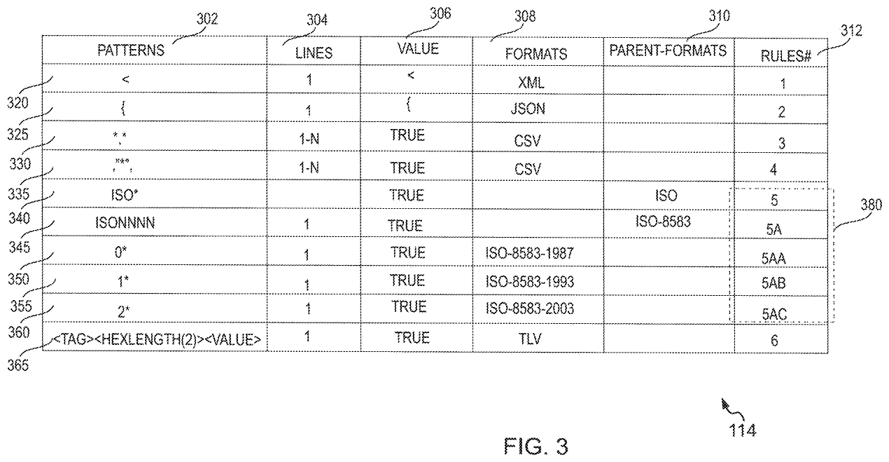

At 204, the payment server 108 applies an applicable rule fetched by a rule engine (e.g., the rule engine 112 of FIG. 1) from a rule data dictionary (e.g., the rule data dictionary 114 of FIG. 1). In an embodiment, the rule engine 112 is configured to match a pattern of an at least one rule from among one or more rules present in the rule data dictionary 114 with one or more characters of the received message to identify the corresponding message format. The rule data dictionary 114 is configured to include a complex rules structure with a parent-child relationship. The matching of patterns with one or more characters of the message is explained in detail with reference to FIG. 3 hereinafter.

At 206, the payment server 108 checks if a match is found and a format is present for the currently applied rule. For example, if a first character of the message received from the application server 102d starts with a sign I′ and a pattern I′ is present in the rule data dictionary 114 for rule #2, it is checked if there exists a corresponding message format present for the rule #2. If the match is not found, the payment server 108 applies a next applicable rule fetched by the rule engine from the rule data dictionary at 204. The steps 204 and 206 are applied until a match is found and a format is present for the currently applied rule.

At 208, the payment server 108 finds the message format. For example, for the currently applied rule #2, a corresponding format ‘JSON’ is present in the rule data dictionary 114. Therefore, ‘JSON’ format is identified as the message format of the received message. In an example embodiment, after discovering the message format, the payment server 108 is configured to verify if the discovered message format is in ISO 8583. If not, the discovered message format e.g., ‘JSON’ is transformed into ISO 8583. Thereafter, the payment service request being issuer response to request for funds is retrieved from the message by parsing the message. Corresponding actions are performed to complete the process. A response for the processed payment service request is generated. The response is transformed from the ISO 8583 format to the discovered message format i.e., ‘JSON’. The response in ‘JSON’ format is sent back to the application server 102d. The process completes at 208.

Thus, a technical effect of message format discovery completed by the payment server 108 is a more flexible and less cumbersome solution for the application servers 102a-n than having to always send the messages in the message format acceptable by the payment server 108. Also, the payment server 108 is saved from providing different network ports for each customers of the payment network 120 for receiving plurality of messages in plurality of message formats which requires a lot of configuration and monitoring.

FIG. 3 represents a simplified schematic representation of the rule data dictionary 114 for message format discovery, in accordance with an example embodiment. As shown, the rule data dictionary 114 includes a listing of one or more rules (as represented by rows 320, 325, 330, 335, 340, 345, 350, 355, 360 and 365) to be applied on the received message for message format discovery. The columns of the rule data dictionary 114 represent a plurality of parameters required to apply the corresponding rules for message format dictionary. For example, columns include, a listing of patterns 302, a listing of lines 304, a listing of values 306, a listing of formats 308, a listing of parent formats 310 and a listing of rule numbers (rule #) 312.

As shown, a row 320 represents that the rule #1 is applied when the pattern ‘<’ with a value ‘<’ matches with the one or more characters in line ‘1’ of the received message. Thereafter, it is checked whether there exists a format or a parent format for the applied rule. As shown in the row 320, there exists a format AMU for the rule #1. Likewise, each row represents patterns to be matched with the one or more characters in the one or more lines (e.g., 1-N) of the message to apply the corresponding rules. When the message comes in batches, more than one line of the message is required to be checked for matching the pattern. The value column 306 signifies a condition. For example, if it is ‘true’ that each character in lines ‘1-3’ of the received message is separated by a (coma), the rule #3 is applied and a corresponding format ‘CSV’ is identified. Further, an empty cell in the format column 308 signifies that there exists a parent message format which needs to be identified first.

In an example embodiment, once the message is received into the payment network 120, it is categorized into one or more message formats such as ISO, XML, JSON or other. If the first character of the message is ‘<’, the message format is identified as ‘XML’ (see, row 320). If the first character of the message is I′, the message format is identified as ‘JSON’ (see, row 325). The rule data dictionary 114 is configured to include parent-child relationship of the rules. One such example is shown by a dotted box 380 in FIG. 3. For example, If the message starts with characters ‘ISO’, the message format is identified as ‘ISO’ (see, row 340, rule #5). If out of first 12 characters of message, first 4 character are numeric and next 8 characters are hexadecimal characters, the message format is identified as ‘ISO 8583’ (see, row 345, rule #5A). If the first character of the first 4 numeric characters (i.e., 0xxx) in the message in the ISO 8583 format is ‘0’, the message format is identified as ‘ISO 8583-1987’ (see, row 350, rule #5AA). If the first character of the first 4 numeric characters (i.e., 1xxx) in the message in the ISO 8583 format is ‘1’, the message format is identified as ‘ISO 8583-1993’ (see, row 355, rule #5AB). If the first character of the first 4 numeric characters (i.e., 2xxx) in the message in the ISO 8583 format is ‘2’, the message format is identified as ‘ISO 8583-2003’ (see, row 350, rule #5AC).

The message format ISO 8583 defines a specific format where each message in that format may contain a bit map that specifies the data fields that appear in the message, a message type identifier, and those fields that are needed for the specific function intended. The message header contains basic message identifiers and routing information, along with message processing control codes and flags. The message type identifier is a four-digit numeric field that specifies the message class and the category of the function that is to be implemented. For instance, 0100 may indicate a transaction authorization request, 0200 may indicate an acquirer financial request for funds typically from an ATM or a POS terminal and the like. In addition to a primary bit map, messages can include secondary bit maps. Each map typically contains 64-bit fields, corresponding to the number of possible fields in a message. The data fields contain the information needed to process a message.

Further, in ISO message, the primary bitmap starts from fifth character in the message. If first bit of fifth byte is ON, the secondary bitmap is present. Further, a Primary Account Number (PAN) of a customer starts at thirteenth character in the message, if the secondary bitmap is absent. Whereas, the PAN of a customer starts at twenty first character, if the secondary bitmap is present in the message. From the first character of PAN, a payment network (e.g., Mastercard®, VISA, RUPAY, etc.) of the customer is identified. This may further assist in knowing if the payment transaction request/message is received from a customer or a non-customer.

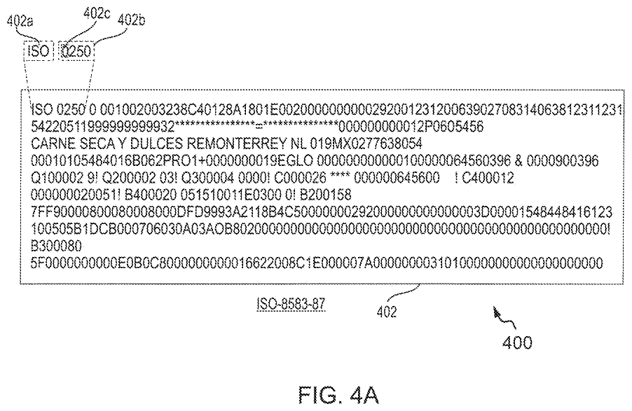

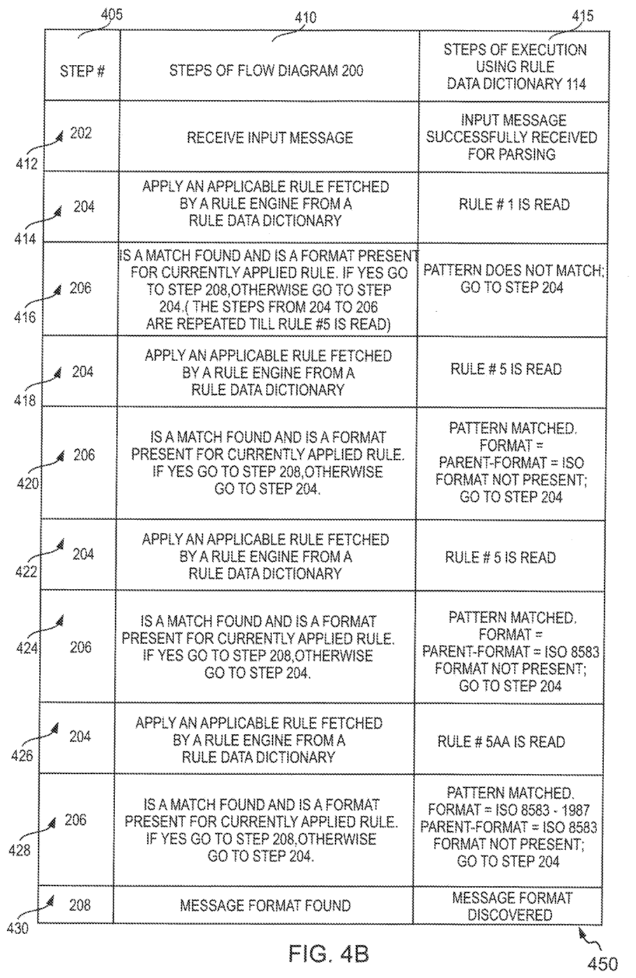

FIGS. 4A & 4B respectively represent an example representation 400 of a message format and an execution 450 of steps of the flow diagram 200 for discovering the message format of FIG. 4A, in accordance with an example embodiment. A message 402 is shown in ISO 8583-1987 format. In an embodiment, the message 402 is received by the payment server 108 from an application server 102a. The payment server 108 is configured to execute steps of the flow diagram 200 using the rule engine 112 and the rule data dictionary 114 (as explained with reference to FIG. 3) to identify the message format of the message 402. This is explained in detail with reference to FIG. 4B hereinafter. The columns represent steps numbers (step #) shown in column 405 in FIG. 4B, steps of flow diagram 200 shown in column 410 in FIG. 4B and steps execution using rule data dictionary 114 shown in column 415 in FIG. 4B. The rows 412-430 represent execution of the rule application based on the steps of the flow diagram 200.

A row 412 shows the message 402 is received successfully for message format discovery and parsing (step #202). A row 414 shows a next applicable rule fetched by the rule engine 112 from the rule data dictionary 114 to be applied (step #204). i.e., rule #1 is read from the rule data dictionary 114. A row 416 shows step #206 at which it is checked if a match is found and a format is present for the currently applied rule. The first character of the message 402 does not start with pattern ‘<’ for the currently applied rule #1. Steps #204 and #206 are repeated till rule #5 is read from the rule data dictionary 114. Therefore, rule #2 for the pattern ‘{’, rule #3 for the pattern ‘*,*’ and rule #4 for the pattern ‘,“*”’; are checked for matching with the one or more characters of the message 402 but are not applied as the respective patters do not match.

A row 418 shows rule #5 is read (step #204). The first 3 characters of the message 402 are ‘ISO’ (see, 402a of FIG. 4A). The rule data dictionary 114 of FIG. 3 mentions ‘ISO’ as parent format. Therefore, a row 420 shows parent format ISO found. A row 422 shows step #204 at which next applicable rule #5A is applied. The message 402 includes next 4 characters numeric as ‘0250’ (see, 402b of FIG. 4A). The rule data dictionary 114 mentions ‘ISO 8583’ as parent format for the currently applied rule #5A. Therefore, a row 424 shows parent format ISO 8583 found. A row 426 shows step #204 at which next applicable rule #5AA is applied. The 4 numeric characters ‘0250’ (see, 402b of FIG. 4A) of the message 402 includes first character as ‘0’ (see, 402c of FIG. 4A). The rule data dictionary 114 mentions ‘ISO 8583-1987’ as format for the currently applied rule #5AA. Therefore, a row 428 shows format ISO 8583-1987 found. A row 430 shows step #208 that the message format ISO 8583-198 is identified for the message 402. As the message 402 is already in the standard format acceptable by the payment server 108, it does not need any transformation and the message is parsed to retrieve the underlying payment service request. The payment service request is processed and a response is sent in the ISO 8583-1987 to the application server.

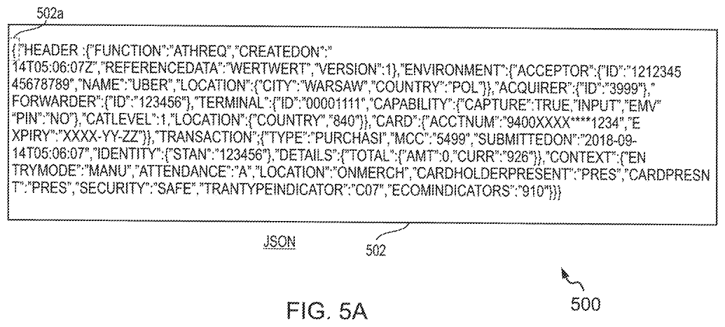

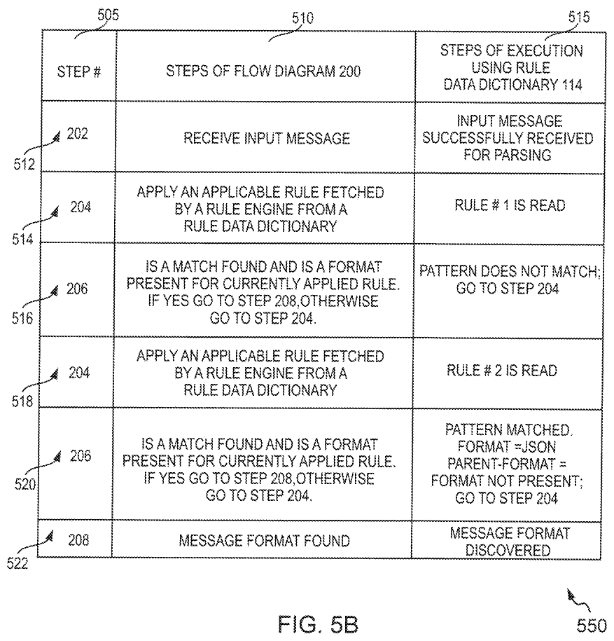

FIGS. 5A & 5B respectively represent an example representation 500 of a message format and an execution 550 of steps of the flow diagram 200 for discovering the message format of FIG. 5A, in accordance with an example embodiment. A message 502 is shown in JSON format. In an embodiment, the message 502 is received by the payment server 108 from an application server 102b. The payment server 108 is configured to execute steps of the flow diagram 200 using the rule engine 112 and the rule data dictionary 114 (as explained with reference to FIG. 3) to identify the message format of the message 502. This is explained in detail with reference to FIG. 5B hereinafter. The columns represent steps numbers (step #) 505, steps of flow diagram 200 shown in column 510 and steps execution using rule data dictionary 114 shown in column 515. The rows 512-522 represent execution of the rule application based on the steps of the flow diagram 200.

A row 512 shows the message 502 is received successfully for message format discovery and parsing (step #202). A row 514 shows a next applicable rule fetched by the rule engine 112 from the rule data dictionary 114 applied (step #204). i.e., rule #1 is read from the rule data dictionary 114. A row 516 shows step #206 at which it is checked if a match is found and a format is present for the currently applied rule. The first character of the message 502 i.e., ‘{’ does not start with pattern ‘<’ for the currently applied rule #1. A row 518 shows a next applicable rule fetched by the rule engine 112 from the rule data dictionary 114 applied (step #204). i.e., rule #2 is read from the rule data dictionary 114. The first character of the message 502 is ‘{’ (see, 502a of FIG. 5A). The rule data dictionary 114 of FIG. 3 mentions ‘JSON’ as format for the matched pattern of the applied rule #2. Therefore, a row 520 shows parent format JOSN found. A row 522 shows step #208 that the message format JSON is identified for the message 502. In an example embodiment, the logic of the steps of the flow diagram 200 and the rule engine 112 are built in a way that it can be scalable and can identify any level of sub-formats or any new format that is not already existing in the rule data dictionary 114.

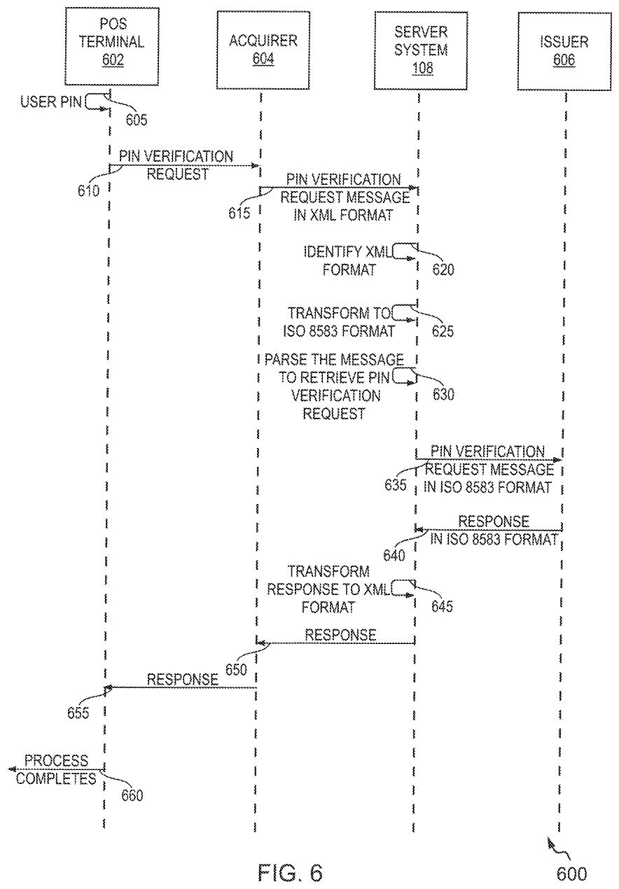

FIG. 6 represents a flow diagram 600 representing discovery of a message format during a payment transaction in a payment network, in accordance with an example embodiment. The sequence of operations of the flow diagram 600 may not be necessarily executed in the same order as they are presented. Further, one or more operations may be grouped together and performed in form of a single step, or one operation may have several sub-steps that may be performed in parallel or in sequential manner. More specifically, the flow diagram 600 explains a message format discovery of a payment transaction request (i.e., a pin verification request sent in a custom message format by a customer during a payment transaction) sent by an application server being an acquirer server in a payment network to the payment server 108. A payment system is represented in which a credit/debit card user uses a payment card interchange network, such as, payment network 120 of FIG. 1. Examples of payment interchange network include, but not limited to, Mastercard® payment system interchange network. The payment network 120 includes various entities such as a POS terminal 602, an acquirer server 604, the payment server 108 and an issuer server 606.

The POS terminal 602 as shown in FIG. 6 may be considered as an example of the client device. The acquirer server 604 is configured to host a payment application on the POS terminal 602 on which a customer/user can tender payment for a purchase from a facility such as a merchant using a payment card. The issuer server 606 is associated with an issuing bank in which a user may have an account (e.g., a cardholder account) and which issues a payment card, such as a credit card or a debit card, to the user. The payment card is linked to the user's account. To accept payment with the payment card, the merchant must normally establish an account with a financial institution that is part of the financial payment system. This financial institution is usually called the merchant bank or the acquirer bank. The acquirer server 604 is associated with the acquirer bank.

When the user tenders payment for a purchase with a payment card, he may need to enter a PIN (e.g., a four-digit number) (see, 605) of the payment card using the POS terminal 602. The PIN is required to be sent by the merchant for verification to the acquirer server 604 for processing the payment (see, 610).

The POS terminal 602 sends the PIN verification request to the acquirer server 604 by sending the PIN (see, 615). The acquirer server 604 is required to send the PIN verification request to the payment server 108 of the payment network 120.

At 615, the acquirer server 604 sends the message for PIN verification request in XML format to the payment server 108.

At 620, the payment server 108 identifies the message format XML. The XML format is identified by applying rule #1 fetched by the rule engine 112 from the rule data dictionary 114 based on matching first character of the message ‘<’ with the pattern ‘<’ of rule #1 as explained with reference to FIG. 3.

At 625, the message in XML format is transformed into ISO 8583 format by the payment server 108. The payment server 108 includes a transformation module (not shown) configured to facilitate transformation of message formats from and to ISO 8583.

After successful transformation, at 630, the message is parsed to retrieve the PIN verification request. At 635, the payment server 108 sends the message for PIN verification request to the issuer server 606 in the ISO 8583 format.

At 640, the issuer server 606 sends a response to the payment server 108 in ISO 8583 format after verifying the PIN. In an example embodiment, if the issuer server 606 is a non-customer of the payment network 120, the issuer server 606 may send the response in a custom-format such as a JSON format. In that case, the payment server 108 needs to identify the JSON format, transform it into ISO 8583 and parse it to retrieve the response.

At 645, the payment server 108 transforms the response received in ISO 8583 to the native format i.e., XML format for sending to the acquirer server 604. At 650, the response is sent to the acquirer server 604 in the XML format. At 655, the response is forwarded by the acquirer server 604 to the POS terminal 602. Based on the response, the payment transaction proceeds further and the process completes at 660.

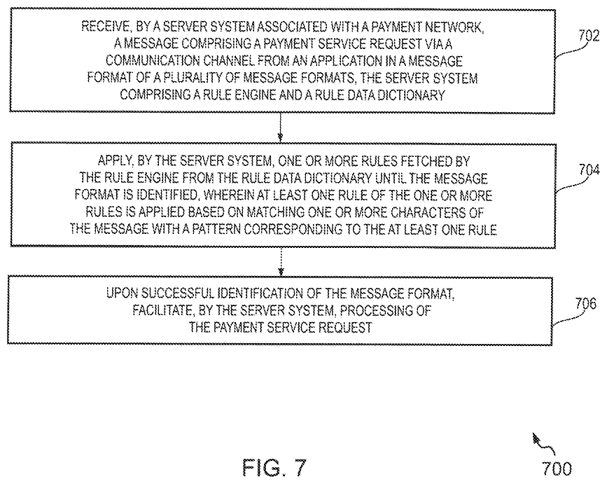

FIG. 7 illustrates a flow diagram of a method 700 for facilitating discovery of a message format in online transaction processing, in accordance with an example embodiment. The method 700 depicted in the flow diagram may be executed by, for example, the at least one server system such as a payment server. Further, the server system may include a rule engine and a rule data dictionary for performing message format discovery. The operations of the method 700, and combinations of operation in the method 700, may be implemented by, for example, hardware, firmware, a processor, circuitry and/or a different device associated with the execution of software that includes one or more computer program instructions. The method 700 starts at operation 702.

At 702, the method 700 receiving, by a server system associated with a payment network, a message including a payment service request via a communication channel from an application in a message format of a plurality of message formats. The server system includes a rule engine and a rule data dictionary. The example of the network communication channel includes Transmission Control Protocol/Internet Protocol (TCP/IP) based communication.

At 704, the method 700 includes, applying, by the server system, one or more rules fetched by the rule engine from the rule data dictionary until the message format is identified. At least one rule of the one or more rules is applied based on matching one or more characters of the message with a pattern corresponding to the at least one rule. As explained with reference to FIG. 3 and FIGS. 4A and 4B, the rules may have complex structure of parent-child relationship.

Upon successful identification of the message format, at 706, the method 700 includes facilitating, by the server system, processing of the payment service request. The method 700 ends at operation 706.

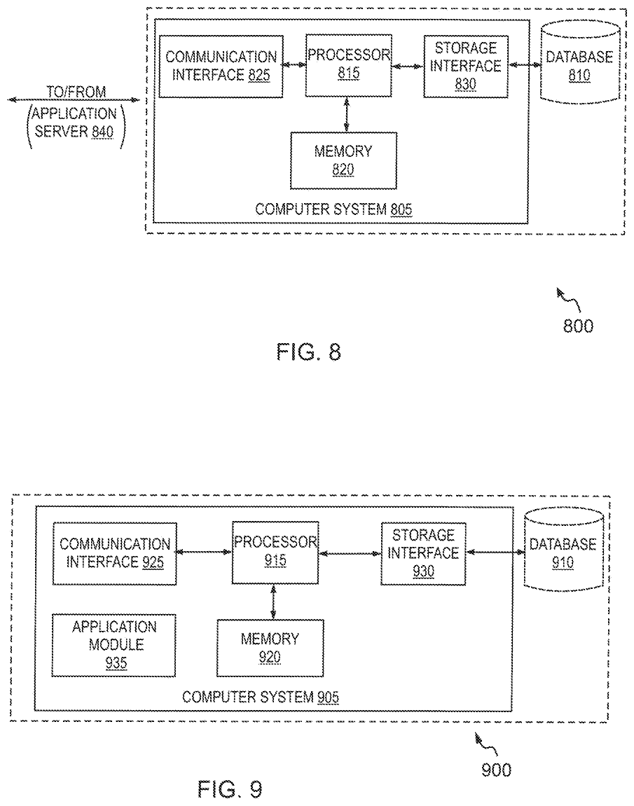

FIG. 8 is a simplified block diagram of a server system 800, in accordance with one embodiment of the present disclosure. The server system 800 is an example of a server system that includes the payment server 108 in the payment network 120 communicatively connected to the application servers 102a-n of FIG. 1. The server system 800 includes a computer system 805, and a database 810. The computer system 805 includes a processor 815 for executing instructions. Instructions may be stored in, for example, but not limited to, a memory 820. The processor 815 may include one or more processing units (e.g., in a multi-core configuration). The processor 815 is operatively coupled to a communication interface 825 such that the computer system 805 can communicate with an application server 840 (that hosts an application that runs on a client device). For example, the communication interface 825 may receive a message of a payment service request in a preferred message format from the application server 840.

The processor 815 may also be operatively coupled to the database 810. The database 810 is any computer-operated hardware suitable for storing and/or retrieving data. The database 810 may include multiple storage units such as hard disks and/or solid-state disks in a redundant array of inexpensive disks (RAID) configuration. The database 810 may include, but not limited to, a storage area network (SAN) and/or a network attached storage (NAS) system. In some embodiments, the database 810 is integrated within the computer system 805. For example, the computer system 805 may include one or more hard disk drives as the database 810. In other embodiments, the database 810 is external to the computer system 805 and may be accessed by the computer system 805 using a storage interface 830. The storage interface 830 is any component capable of providing the processor 815 with access to the database 810. The storage interface 830 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing the processor 815 with access to the database 810.

The processor 815 is configured to apply one or more rules fetched by a rule engine from a rule data dictionary to identify a message format. The processor 815 is further configured to facilitate processing of the payment service request upon successful identification of the message format. The processor 815 is configured to transform the identified message format into a standardized message format acceptable by the server system 800. The processor 815 is configured to parse the message in the standardized message format to retrieve the payment service request. The processor 815 is configured to transform the processed payment request to the message format (i.e., a designated clearing message format) in which the message was originally received from the application server 840. The processor is configured to send the response to the application server 840 via the communication interface 825.

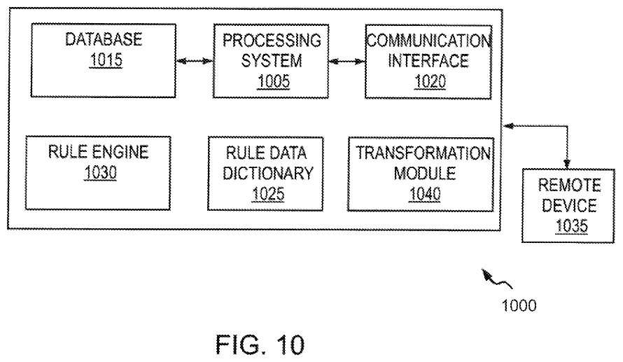

In an embodiment, the communication interface 825 is capable of facilitating operative communication with the application server 840 using API calls. The communication may be achieved over a communication network, such as the communication network 110. The components of the server system 800 provided herein may not be exhaustive, and that the server system 800 may include more or fewer components than that of depicted in FIG. 10. Further, two or more components may be embodied in one single component, and/or one component may be configured using multiple sub-components to achieve the desired functionalities. Some components of the server system 800 may be configured using hardware elements, software elements, firmware elements and/or a combination thereof.

FIG. 9 is a simplified block diagram of an application server 900, in accordance with one embodiment of the present disclosure. The application server 900 is an example of any of the application servers 102a-n of FIG. 1. The application server 900 is also an example of the acquirer server 604 and the issuer server 606 of FIG. 6. The application server 900 includes a computer system 905 and a database 910. The computer system 905 includes a processor 915 for executing instructions. Instructions may be stored in, for example, but not limited to, a memory 920. The processor 915 may include one or more processing units (e.g., in a multi-core configuration). The processor 915 is operatively coupled to a communication interface 925 such that the computer system 905 can communicate with a client device as well as the server system 800. For example, the communication interface 925 may send the payment service request to the server system 800 by means of a message in a preferred message format via the communication interface 925.

The processor 915 may also be operatively coupled to the database 910. The database 910 is any computer-operated hardware suitable for storing and/or retrieving data. The database 910 may include multiple storage units such as hard disks and/or solid-state disks in a redundant array of inexpensive disks (RAID) configuration. The database 910 may include, but not limited to, a storage area network (SAN) and/or a network attached storage (NAS) system. In some embodiments, the database 910 is integrated within the computer system 905. For example, the computer system 905 may include one or more hard disk drives as the database 910. In other embodiments, the database 910 is external to the computer system 905 and may be accessed by the computer system 905 using a storage interface 930. The storage interface 930 is any component capable of providing the processor 915 with access to the database 910. The storage interface 930 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing the processor 915 with access to the database 910.

The computer system 905 further includes an application module 935. The application module 935 is configured to implement features of the application on the client device upon installation. As an example, the application may be a payment transaction application. The application module 935 may be configured to receive payment transaction related information and user information from the client device. The application module 935 further send response to the payment transaction related information and the user information to the client device.

The communication interface 925 is further configured to cause display of user interfaces on the client device using which the user may initiate a payment transaction. In one embodiment, the communication interface 925 includes a transceiver for wirelessly communicating information to, or receiving information from, the server system 800 or other suitable display device, and/or another type of remote processing device. In another embodiment, the communication interface 925 is capable of facilitating operative communication with the remote devices and a cloud server using Application Program Interface (API) calls. The communication may be achieved over a communication network, such as the communication network 110.

FIG. 10 is a simplified block diagram of a payment server 1000 used for message format discovery, in accordance with one embodiment of the present disclosure. The payment server 1000 may correspond to the payment server 108 of FIG. 1. As explained with reference to FIG. 1, the payment server 108 is associated with a payment network 120. The payment network 120 may be used by the application server 840 as a payment interchange network. Examples of the payment interchange network include, but not limited to, Mastercard® payment system interchange network. The payment server 1000 includes a processing system 1005 configured to extract programming instructions from a memory 1010 to provide various features of the present disclosure. The components of the payment server 1000 provided herein may not be exhaustive, and that the payment server 1000 may include more or fewer components than that of depicted in FIG. 10. Further, two or more components may be embodied in one single component, and/or one component may be configured using multiple sub-components to achieve the desired functionalities. Some components of the payment server 1000 may be configured using hardware elements, software elements, firmware elements and/or a combination thereof.

Via a communication interface 1020, the processing system 1005 receives a message from a remote device 1035 such as application server 840 of FIG. 1. The communication may be achieved through API calls, without loss of generality. A rule data dictionary 1025 is operatively coupled to the processing system 1005. The rule data dictionary 1025 includes a listing of one or more rules applicable for identification of the message format in a parent-child relationship. The rule data dictionary 1025 further includes a listing of patterns, a listing of parent formats and a listing of child formats. Each pattern corresponds to each rule of the one or more rules. A parent format is identified based on matching one or more characters of the received message with at least one pattern. The parent format can have one or more children formats. At least one child format is identified based on identification of the parent format and based on matching the one or more characters of the message with at least one pattern. The rule data dictionary 1025 also includes a listing of values where each value forms a respective condition to identify the message format.

Further, a rule engine 1030 is shown operatively coupled to the processing system 1005. The rule engine 1030 is capable of fetching the applicable rules from the rule data dictionary 1025 and provide to the processing system 1005 to apply for the message format discovery. The processing system 1005, in conjunction with a transformation module 1040, is configured to transform the identified message format into a standard message format if it is not originally received in the standard message format. The transformation module 1040 is further configured to transform the standard message format into the originally received message format after the payment service request is processed by the processing system 1005. Via the communication interface 1020, the response of the processed payment service request is sent by the processing system 1005 to the remote device 1035. The database 1015 is configured to store plurality of message formats in which the messages may be received by the payment server 1000 from customer as well as non-customer applications.

The disclosed method with reference to FIG. 7, or one or more operations of the method 700 may be implemented using software including computer-executable instructions stored on one or more computer-readable media (e.g., non-transitory computer-readable media, such as one or more optical media discs, volatile memory components (e.g., DRAM or SRAM), or nonvolatile memory or storage components (e.g., hard drives or solid-state nonvolatile memory components, such as Flash memory components) and executed on a computer (e.g., any suitable computer, such as a laptop computer, net book, Web book, tablet computing device, smart phone, or other mobile computing device). Such software may be executed, for example, on a single local computer or in a network environment (e.g., via the Internet, a wide-area network, a local-area network, a remote web-based server, a client-server network (such as a cloud computing network), or other such network) using one or more network computers. Additionally, any of the intermediate or final data created and used during implementation of the disclosed methods or systems may also be stored on one or more computer-readable media (e.g., non-transitory computer-readable media) and are considered to be within the scope of the disclosed technology. Furthermore, any of the software-based embodiments may be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

Although the invention has been described with reference to specific exemplary embodiments, it is noted that various modifications and changes may be made to these embodiments without departing from the broad spirit and scope of the invention. For example, the various operations, blocks, etc., described herein may be enabled and operated using hardware circuitry (for example, complementary metal oxide semiconductor (CMOS) based logic circuitry), firmware, software and/or any combination of hardware, firmware, and/or software (for example, embodied in a machine-readable medium). For example, the apparatuses and methods may be embodied using transistors, logic gates, and electrical circuits (for example, application specific integrated circuit (ASIC) circuitry and/or in Digital Signal Processor (DSP) circuitry).

Particularly, the server system 800 and its various components such as the computer system 805 and the database 810 may be enabled using software and/or using transistors, logic gates, and electrical circuits (for example, integrated circuit circuitry such as ASIC circuitry). Various embodiments of the invention may include one or more computer programs stored or otherwise embodied on a computer-readable medium, wherein the computer programs are configured to cause a processor or computer to perform one or more operations. A computer-readable medium storing, embodying, or encoded with a computer program, or similar language, may be embodied as a tangible data storage device storing one or more software programs that are configured to cause a processor or computer to perform one or more operations. Such operations may be, for example, any of the steps or operations described herein. In some embodiments, the computer programs may be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (compact disc read only memory), CD-R (compact disc recordable), CD-R/W (compact disc rewritable), DVD (Digital Versatile Disc), BD (BLU-RAYED Disc), and semiconductor memories (such as mask ROM, PROM (programmable ROM), EPROM (erasable PROM), flash memory, RAM (random access memory), etc.). Additionally, a tangible data storage device may be embodied as one or more volatile memory devices, one or more non-volatile memory devices, and/or a combination of one or more volatile memory devices and non-volatile memory devices. In some embodiments, the computer programs may be provided to a computer using any type of transitory computer readable media. Examples of transitory computer readable media include electric signals, optical signals, and electromagnetic waves. Transitory computer readable media can provide the program to a computer via a wired communication line (e.g., electric wires, and optical fibers) or a wireless communication line.

Various embodiments of the invention, as discussed above, may be practiced with steps and/or operations in a different order, and/or with hardware elements in configurations, which are different than those which, are disclosed. Therefore, although the invention has been described based upon these exemplary embodiments, it is noted that certain modifications, variations, and alternative constructions may be apparent and well within the spirit and scope of the invention.

Although various exemplary embodiments of the invention are described herein in a language specific to structural features and/or methodological acts, the subject matter defined in the appended claims is not necessarily limited to the specific features or acts described above. Rather, the specific features and acts described above are disclosed as exemplary forms of implementing the claims.

1. A method for processing a payment service request, the method comprising:
receiving, by a server system associated with a payment network, a message comprising the payment service request via a communication channel from an application in a message format of a plurality of message formats, the server system comprising a rule engine and a rule data dictionary;
applying, by the server system, one or more rules fetched by the rule engine from the rule data dictionary until the message format is identified, wherein at least one rule of the one or more rules is applied based on matching one or more characters of the message with a pattern corresponding to the at least one rule; and
upon successful identification of the message format, facilitating, by the server system, processing of the payment service request.

2. The method as claimed in claim 1, further comprising:
transforming the identified message format into a standardized message format acceptable by the server system.

3. The method as claimed in claim 2, further comprising:
parsing the message in the standardized message format to retrieve the payment service request; and
processing the payment service request.

4. The method as claimed in claim 3, further comprising:
transforming the processed payment request to a designated clearing message format.

5. The method as claimed in claim 4, wherein the designated clearing message format at least comprises the message format of the message sent by the application.

6. The method as claimed in claim 2, wherein the standardized message format is an International Organization for Standardization (ISO) 8583 message format.

7. The method as claimed in claim 1, wherein the one or more rules in the rule data dictionary comprise a parent-child relationship.

8. The method as claimed in claim 7, further comprising:
identifying a parent format of the message, wherein the parent format is identified based on matching the one or more characters of the message with a pattern corresponding to a parent rule.

9. The method as claimed in claim 8, further comprising:
identifying at least one child format of the identified parent format to identify the message format, wherein the at least one child format is identified based on matching the one or more characters of the message with a pattern corresponding to at least one child rule.

10. A server system in a payment network for processing a payment service request, the server system comprising:
a communication interface configured to receive a message comprising the payment service request via a communication channel from an application in a message format of a plurality of message formats;
a memory comprising executable instructions;
a rule data dictionary comprising one or more rules;
a rule data engine configured to fetch one or more rules from the rule data dictionary until the message format is identified; and
a processor communicably coupled to the communication interface, the rule data dictionary and the rule engine, the processor configured to execute the instructions to cause the server system to at least:
apply the one or more rules fetched by the rule engine from the rule data dictionary until the message format is identified, wherein at least one rule of the one or more rules is applied based on matching one or more characters of the message with a pattern corresponding to the at least one rule; and
upon successful identification of the message format, facilitate processing of the payment service request.

11. The server system as claimed in claim 10, wherein the server system is further caused to at least:
transform the identified message format into a standardized message format acceptable by the server system.

12. The server system as claimed in claim 11, wherein the server system is further caused to at least:
parse the message in the standardized message format to retrieve the payment service request; and
process the payment service request.

13. The server system as claimed in claim 12, wherein the server system is further caused to at least:
transform the processed payment request to a designated clearing message format.

14. The server system as claimed in claim 13, wherein the designated clearing message format at least comprises the message format of the message sent by the application.

15. The server system as claimed in claim 11, wherein the standardized message format is an International Organization for Standardization (ISO) 8583 message format.

16. The server system as claimed in claim 10, wherein the one or more rules in the rule data dictionary comprise a parent-child relationship.

17. The server system as claimed in claim 16, wherein the server system is further caused to at least:
identify a parent format of the message, wherein the parent format is identified based on matching the one or more characters of the message with a pattern corresponding to a parent rule.

18. The server system as claimed in claim 17, wherein the server system is further caused to at least:
identify at least one child format of the identified parent format to identify the message format, wherein the at least one child format is identified based on matching the one or more characters of the message with a pattern corresponding to at least one child rule.

19. A method for processing messages in a payment network, the method comprising:
receiving, by a server system associated with the payment network, from a sender, a first message in a first message format of a plurality of message formats;
applying, by the server system, one or more rules from a rule data dictionary until the first message format is identified, wherein at least one rule of the one or more rules is applied based on matching one or more characters of the message with a pattern corresponding to the at least one rule; and
transforming, by the server system, the first message into a second message format;
transmitting, by the server system, the transformed first message to a recipient that uses the second message format;
receiving, by the server system from the recipient, a response to the transformed first message;
transforming, by the server system, the response to the first message format; and
transmitting, by the server system, the transformed response to the sender.

20. The method of claim 19, wherein the response is received in a third message format, the message further comprising:
applying the one or more rules until the third message format is identified;
wherein transforming the response to the first message format comprises transforming the response from the third message format to the first message format; and
